(19) United States
(12) Patent Application Publication
(10) Pub. No.: US 2003/0228560 A1
(43) Pub. Date: Dec. 11, 2003

(54) Applied instructional system

(75) Inventors: Janie Elaine Seat, Knoxville, TN (US); John R. Owens, Clinton, TN (US); Melissa M. Portwood, Knoxville, TN (US); Karen S. Rogers, Knoxville, TN (US)

Correspondence Address: LUEDEKA, NEELY & GRAHAM, P.C., P O BOX 1871, KNOXVILLE, TN, 37901, US

(73) Assignee: BWXT Y-12, LLC

(21) Appl. No.: 10/164,505

(22) Filed: Jun. 6, 2002

(51) Int. Cl. G09B 19/00

(52) U.S. Cl. 434/219

(57) ABSTRACT

A process for computer-assisted teaching, which is also known as computer-aided-instruction and computer-based-training is disclosed. Computer simulation may be used to present images which depict an actual physical system that is operated by user actions on a physical control panel. The process is particularly adaptable for teaching persons how to use and maintain various types of industrial machines, teaching students various scientific phenomena and processes, teaching office workers how to use computers and various other office machines, and teaching homeowners how to use various consumer products. Some embodiments are implemented as a two part instructional program comprising (1) presenting a curriculum to the learner that typically includes background material followed by tutorial material which may include a flow chart illustrating the steps for achieving a desired result with a specific process or apparatus based on a specific example and then visually depicting the outcome of performing those steps on the process or apparatus, and then (2) providing a computer-generated “laboratory” wherein the learner uses a simulated controller to perform steps similar to those taught in the curriculum to accomplish a slightly different desired result, and then visually depicting the outcome of those steps on the process or apparatus, followed by a quantitative and/or qualitative comparison of the outcome with the desired result. The process can be enhanced by adding a simulated functional test of the results from the illustrated example in part (1) to further demonstrate that the desired result was achieved, and/or adding a comparable simulated functional test of the learner's work in part (2) to demonstrate visually whether the slightly different intended objectives were achieved by the student's use of the simulated controller.

The U.S. Government has rights to this invention pursuant to contract number DE-AC05-00OR22800 between the U.S. Department of Energy and BWXT Y-12, L.L.C.

### FIELD OF THE INVENTION

The present invention relates to computer-aided instruction using computer simulation, and in particular instruction related to the operation of apparatuses and processes.

### BACKGROUND

There is a widespread need for improved training methods and devices. Training is typically needed for such purposes as teaching persons how to use and maintain various types of industrial machines, teaching students various scientific phenomena and processes, teaching office workers how to use to computers and various other office machines, and teaching consumers how to use various retail products. Historically, one approach to such training has been to use the actual machine or object to demonstrate its operation and maintenance, and to permit the trainee or student to practice using it. This approach has a number of inherent problems. First, this ties up the use of equipment which could be utilized for more profitable purposes. Second, the equipment may be damaged by the learner. Third, the trainee or student may be injured as the result of improper operation of the product or process. Fourth, this method typically generates a large quantity of scrap output which is wasteful and expensive. Accordingly there is a need for a comprehensive computer-based approach for teaching the skills necessary to operate and maintain industrial machinery and other devices, and for teaching basic and applied sciences.

### SUMMARY

The foregoing and other needs are met by a computer-based method for teaching a student the proper manner of providing input to a process or apparatus in order to achieve a desired outcome from the process or apparatus. In a preferred embodiment a method first provides the student with background reference material which is relevant to the application of input to the process or apparatus. Then the method illustrates to the student an example of input to the process or apparatus that is proper to achieve a specified outcome on an element of the process or apparatus and presents to the student a simulation of the outcome on that element of the process or apparatus. Next the method poses to the student a desired outcome of the process or apparatus and collects input from the student which the student proposes as being appropriate to achieve that desired outcome. Finally the method presents to the student a simulation of the resulting outcome from that input to the process or apparatus.

As explained in more detail hereinafter, an alternate embodiment of the preferred method may add the step of conducting a simulated functional test on either (1) the results of the illustrated tutorial method of input to the process or apparatus, and/or (2) the results of the student's postulated input to the process or apparatus. This preferred alternate embodiment may also use a simulation controller to illustrate and accept the student's entry of input to the process or apparatus. Such simulation controller may be a generic simulation controller based upon several commercial process or apparatus control devices, or a hypothetical simulation controller based upon the theory of operation of the process or apparatus. If a generic simulation controller is initially used, further instruction may be provided using a commercial simulation controller which is designed to appear and function as a commercially marketed control device.

Some embodiments of this invention comprise computer software for teaching a student the proper manner of providing input to a process or apparatus in order to achieve a desired outcome from the system which includes a curriculum of background material, and tutorial material; and includes a laboratory which contains a simulation controller and a simulation engine; and includes an communication exchanger. The tutorial material may include a flow-chart and the flow-chart may include two or more branches from which the student may select instructional material. The laboratory may provide a jump path to go from the laboratory back to the curriculum, and the curriculum may include a return path such that the student may return back to the laboratory from the curriculum. The communication exchanger may be a command line argument, an environment setting, a shared file, or a custom function.

### BRIEF DESCRIPTION OF THE DRAWINGS

Referring now to the drawings in which like reference characters designate like or corresponding parts throughout the several views, there are shown several embodiments of the invention. It will be understood that the various embodiments shown are intended as examples and do not limit the scope of the invention.

FIG. 1 illustrates the overall concept of one embodiment of the invention, showing a general flow of a process for computer-assisted teaching.

FIG. 2 is a screen-shot of a part of an embodiment of the invention showing how a student is taught the first step in the construction of a specific CNC program for cutting a quarter circle.

FIG. 3 is a screen-shot of the same embodiment representation of FIG. 2, showing how the teaching process has progressed to the fifth step in the construction of a specific CNC program for cutting a quarter circle.

FIG. 4 is a screen-shot of the same embodiment representation of FIGS. 2 and 3, showing how the teaching process proceeds to ask the student to practice the method that has been taught.

FIG. 5 is a screen-shot of a portion of an embodiment of the invention in which a generic process controller is shown on the left of the screen and a simulation of the process is shown on the right of the screen.

FIG. 6 is a screen-shot of a portion of an embodiment of the invention which illustrates the use of a pop-up window to permit input by a student.

FIG. 7 is a screen-shot of a portion of an embodiment of the invention which illustrates part of the evaluation of a student's performance that has been tested.

### DETAILED DESCRIPTION OF PREFERRED EMBODIMENTS

Described next are several embodiments of this invention from which modifications will be apparent to those skilled in the art without departing from the metes and bounds of the invention. In order to understand these embodiments it is helpful to define some terminology, as follows.

A “system” is defined as a process or an apparatus;

an “element” is defined as a step or an output of a process, or a component or configuration of an apparatus;

a “demonstrated element” is defined as an element that is used for illustrating the operation of a system to a student

a “tested element” is defined as an element for which a student's ability to modify is tested;

“operational input” is defined as an activity that modifies or adjusts one or more elements of the system;

“demonstrated operational input” is defined as appropriate operational input necessary to achieve a demonstrated operational outcome for a system which is illustrated to a student;

“postulated operational input” is defined as operational input which is created by a student as the suggested activity necessary to achieve a desired outcome of a system;

“operational outcome” is defined as a change in a physical, chemical, electrical or temporal property of an element of a system that results from operational input;

“demonstrated operational outcome” is defined as operational outcome for a system resulting from demonstrated operational input that is taught to a student;

“desired operational outcome” is defined as operational outcome for a system that a student's ability to achieve is being tested;

“resulting operational outcome” is defined as the operational outcome produced by the system as a result of postulated operational input;

“simulation engine” is defined as a data processing module that simulates an operational outcome based upon a parameter corresponding to operational input, which may include a computer-generated visual display of the physical appearance of a system;

“simulation controller” is defined as a computer-generated control panel that is used to enter at least one parameter corresponding to operational input to control a simulation engine;

“generic simulation controller” is defined as a simulation controller that has individual control features which are common to control features of at least one commercial physical control panel but collectively the control features may be different in number or layout from any specific commercial physical control panel, and wherein the generic simulation controller may have fewer control features than a typical commercial physical controller but every operational input for a physical system is included in the generic simulation controller if it (1) is taught in the curriculum, and (2) is normally entered at least in part by via a physical control panel in a physical system;

“commercial simulation controller” is defined as a simulation controller that is designed to appear and operate substantially like an actual physical control panel that is used to operate a commercially available physical system;

“hypothetical simulation controller” is defined as a simulation controller that is designed to enter operational input for a theoretical system that does not physically exist; and

“simulated functional test” when used as part of a tutorial is defined as the computer-generated comparison of a desired operational outcome on at least one element of a system with the demonstrated operational outcome on the same element(s) based upon demonstrated operational input; “simulated functional test” when used as a test of the accuracy of a student's work is defined as the computer-generated comparison of a desired operational outcome on at least one element of a system with the resulting operational outcome on the same element(s) based upon postulated operational input.

The computer-aided-instruction program of one embodiment divides the overall subject matter to be learned into multiple segments that are taught sequentially. For example, in a computer-aided-instruction program where the overall subject matter is teaching the programming of computer numerical control machining tools, the program segments may comprise (1) a process introduction, (2) several math tutorials, (3) and multiple segments on how to program the computer numerical control machine so that it will cut certain features into a block of material (workpiece). The various segments are often presented in a pattern of graded difficulty. For example, the segments in any particular computer-aided-instruction program may increase in difficulty as the student progresses through them. Also, several computer-aided-instruction programs may be grouped together with each program being successively more difficult. An example of this would be a series of three computer-aided-instruction programs: one for apprentices, a second for the journeyman level, and a third for master craftsmen.

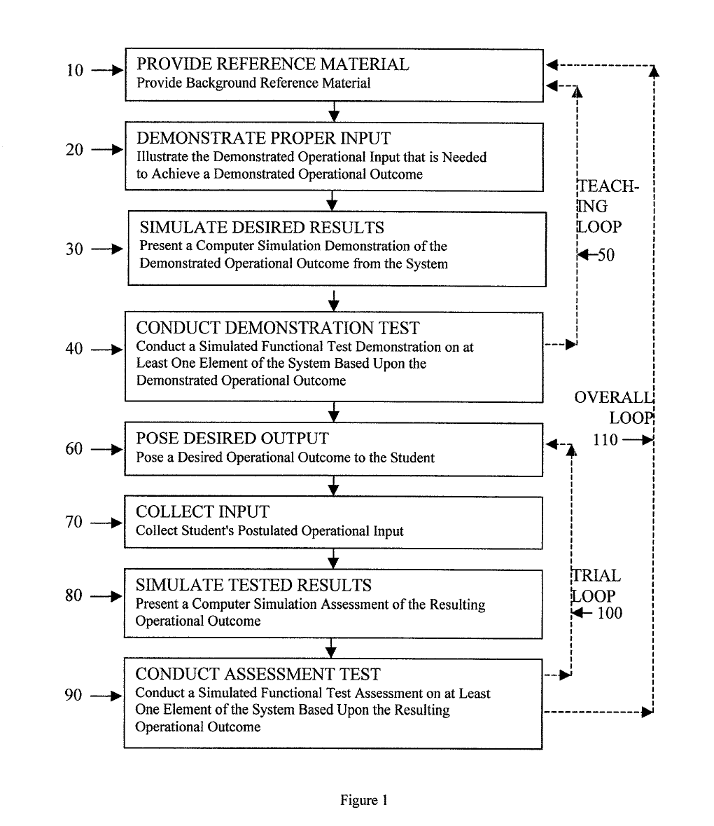

FIG. 1 represents the typical flow through one segment of such instruction using one embodiment of this invention. The process in this embodiment for a given instruction segment preferably begins with PROVIDE REFERENCE MATERIAL 10 to the student. This material may consist of a course introduction, or narrative explanations related to the general subject being taught, or math, science, or other tutorials designed to emphasize particular skills that are needed, as well as specific examples of operational input necessary to achieve a desired outcome, and so forth. These instructional components are referred to as background material and are typically presented as computer-assisted-instruction segments. Once that background material has been presented, in this embodiment the program proceeds to DEMONSTRATE PROPER INPUT 20 whereby the student is shown demonstrated operational input that is needed to achieve a demonstrated operational outcome. This material is referred to as tutorial material and is preferably one or more simple examples to illustrate one of the principles of the subject matter being taught. For example, in a computer-aided instructional system designed to teach computer numerical control machining, the demonstrated operational input may be a computer numerical control program directing a computer numerical control machine to make a particular cut, for example a specified quarter-circle arc, in a workpiece, in which case the demonstrated operational outcome would be the specified quarter circle arc cut into the workpiece. The computer-assisted-instruction program typically uses a simulation controller (often a generic simulation controller) to illustrate methods for feeding the demonstrated operational input into the system. Next in this embodiment, the program moves to the SIMULATE DESIRED RESULTS 30 step wherein the student is presented with a computer simulation demonstration of the demonstrated operational outcome from the system. In the computer numerical control example being described this would show the movement of the machine and tools as they cut the arc in the workpiece. Preferably this is a 3-dimensional perspective animated visual image created by a simulation engine and presented to the student to reinforce the principles being taught. Students generally find such imagery to be an interesting and entertaining way to learn. In some embodiments of this invention, the computer-aided instruction software next proceeds to a CONDUCT DEMONSTRATION TEST 40 step in which it conducts a simulated functional test demonstration on at least one element of the system based upon the demonstrated operational outcome. In the case of a computer-aided-instructional software package designed to teach machining, this may be the simulated image of a caliper applied to a dimensional feature of the simulated workpiece being machined, or the simulated image of a check gage fitting over the workpiece. Preferably such simulated tests are also presented as a 3-dimensional animated visual image. Also preferably, as illustrated by the TEACHING LOOP 50, the student is given the opportunity to repeat the PROVIDE REFERENCE MATERIAL 10 step, the DEMONSTRATE PROPER INPUT 20 step to observe demonstrated operational input, the SIMULATE DESIRED RESULTS 30 step which depicts the demonstrated operational outcome, and (if used) the CONDUCT DEMONSTRATION TEST 40 step to provide a simulated functional test demonstration, as many times as needed in order for the student to feel confident that the material has been learned. Preferably the student may also return to PROVIDE REFERENCE MATERIAL 10 step at any time, if desired. Preferably if the student returns to the PROVIDE REFERENCE MATERIAL 10 step they can proceed back from that step to the step which they previously left.

In this embodiment, steps 10, 20, 30, 40, and 50 comprise steps taken in the “curriculum.” The term curriculum refers to the instructional material (including background information, flow charts, descriptions, demonstrations, etc.) whereby the proper manner of providing operational input to a system in order to achieve a desired operational outcome from the system is presented to the student.

Once the student feels comfortable with the principles being taught in a particular segment of the curriculum, he or she advances to the practice and testing phases, also known as the “laboratory” steps. This phase begins with the POSE DESIRED OUTPUT 60 step in which a desired operational outcome is presented to the student. In a preferred embodiment the desired operational outcome is similar to but distinctly different from the demonstrated operational outcome. In such an embodiment the student is required to extend the knowledge learned from the demonstrated operational outcome in order to achieve the desired operational outcome. For example, in the case of a computer-aided instructional system designed to teach computer numerical control machining, the desired operational outcome may be a semi-circle arc cut that is to be made on a workpiece. In that example, the student would then be given the opportunity to write a program to direct the machine to perform that function preferably using the same simulation controller previously used to illustrate the preparation of demonstrated operational input, and the computer-aided instruction software would proceed to the COLLECT INPUT 70 step in which it collects the student's postulated operational input. The computer-aided instruction software would then proceed to the SIMULATE TESTED RESULTS 80 step in which it presents a computer simulation assessment of the resulting operational outcome, again preferably as a 3-dimensional animated visual image. For example the simulation may depict an actual arc cut in metal plate stock. The computer-aided instructional software may also include a CONDUCT ASSESSMENT TEST 90 step in which it conducts a simulated functional test assessment on at least one element of the system based upon the resulting operational outcome, again preferably as a 3-dimensional animated visual image. For example, in such a simulated test one or more simulated “go-gages” and/or one or more simulated “no-go gages” may be depicted as making a simulated test on the student's simulated arc cut, and the mating contact between the simulated arc cut and the simulated gages graphically depicted as either as “pass” or “fail” results depending on the accuracy of the student's postulated operational input. In some embodiments of this invention more than one measures of merit, such as speed as well as accuracy, may be measured based upon the student's postulated operational input and compared with minimum acceptance standards. Based on these results it is preferred that the student be permitted to repeat the practice or testing phase multiple times, as illustrated by the TRIAL LOOP 18. If the student is in the practice mode the computer-aided-instruction program may allow an unlimited number of repeats through the TRIAL LOOP 18. If the student is in the testing mode the program may limit the student to a small number of attempts through the TRIAL LOOP 18 to successfully achieve the desired operational outcome. Preferably the student may also return from the laboratory to the curriculum at any time, if desired. Preferably if the student returns to the curriculum they can proceed back from that to the precise laboratory step which they previously left.

If the student is in the testing mode and fails to achieve the desired operational outcome in the maximum number of trials, the student is preferably directed to enter the OVERALL LOOP 110 to repeat that segment of the instruction process. The results of the student's performance may be recorded by the computer-aided instruction system and reported to the teacher automatically or upon request. When the student has successfully completed a segment of the instruction process, the computer-aided-instruction system enters the OVERALL LOOP 110 and begins the process anew on the next instruction segment until all instruction segments have been taught or the process is otherwise terminated.

As previously suggested, in this embodiment steps 60, 70, 80, 90, and 18 comprise steps taken in the “laboratory.” The term laboratory refers to the environment where the student can experiment and demonstrate proficiency through the use of a virtual machine.

Note also that in this embodiment the simulation controller used in step 70 in the laboratory may be and preferably is the same one used in step 20 in the curriculum, and the simulation engine used in step 80 in the laboratory is preferably also used in step 30 in the curriculum.

A variation on this embodiment of this invention uses a hypothetical simulation controller to depict demonstrated operational input and collect a student's postulated operational input.

Another alternate embodiment is a computer-assisted-instruction system in which the student is first trained on a generic simulation controller and after successfully completing that training, the student is trained on at least one commercial simulation controller, where the commercial simulation controller preferably performs substantially the same functions as the generic simulation controller. This permits the student to apply general knowledge acquired with the generic simulation controller to the real-world environment of a commercial controller.

### EXAMPLE

One specific embodiment is the Applied Instructional System for Machinists (AISM) training system. The primary purpose of AISM is to teach machinists how to program a computerized numerical control (CNC) machine. The AISM embodiment is preferably implemented as a two part tutorial process comprising in summary (1) presenting a curriculum to the student that includes background material followed by tutorial material that includes a flow chart illustrating the programming steps for a specific machining process based on a specific example and then depicting the results of running that program on the CNC machine, and then (2) providing a computer-generated “laboratory” wherein the student uses a simulated CNC controller to program the same machining process on a slightly different example, and then presenting a computer-generated visual representation of cutting operation, followed by a computer-generated testing operation where the student's program is graded or scored for dimensional accuracy of the fabricated part and other CNC performance parameters.

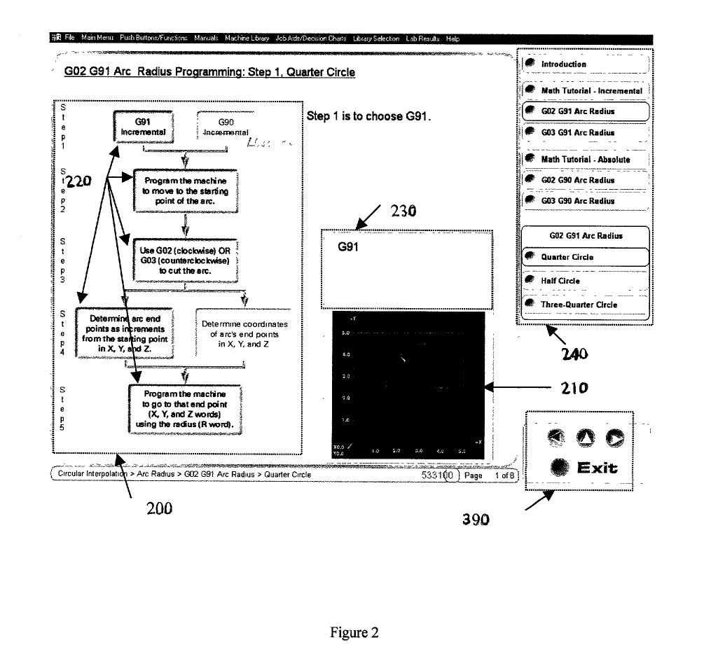

FIG. 2 illustrates the flow chart element 200 of AISM. The student is presented with a multi-step process that will be linear if only one alternative approach is being taught, or branched if comparative approaches are being taught. In this example the flow chart 200 shows two alternative branches: (a) a “G91—Incremental” approach and (b) a “G90—Absolute” approach. “G91—Incremental” refers to a method where the tool cutting track is guided by positioning coordinates that are entered relative to the last position of the cutting tool. “G90—Absolute” refers to a method where the tool cutting track is guided by positioning coordinates that are entered relative to a fixed point of origin (coordinates 0,0,0) on a coordinate axes of three dimensions. If the student lacks sufficient knowledge of the mathematical principles of geometry, background material is provided in the curriculum on such subjects as how to define the locus of a point on a two and three dimensional coordinate axis system and how to calculate the length of a straight line or an arc of a circle. In FIG. 2 the student is being taught the “G91—Incremental” method as illustrated by the fact that the branch for that approach is highlighted and steps related to “G90—Absolute” are dimmed. Presentation of the two alternative branches helps the student put the approach being taught in context with the alternative approach.

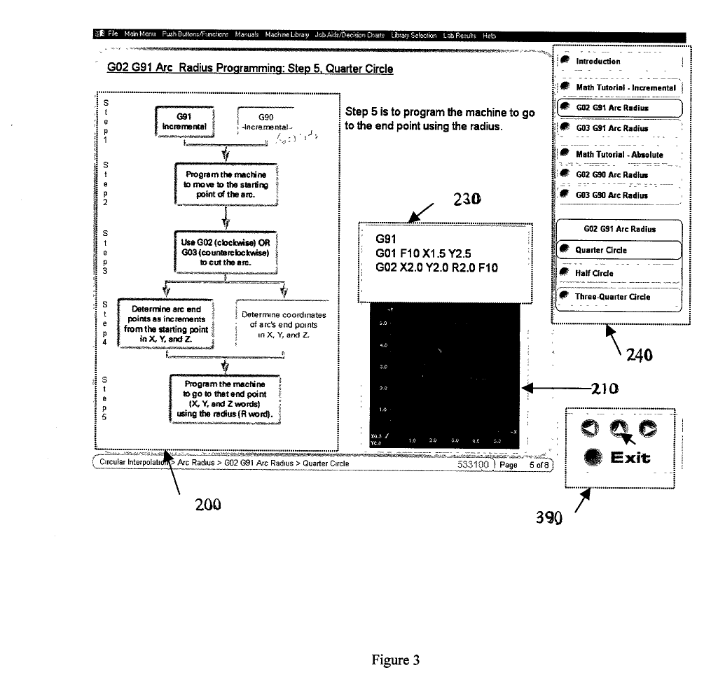

The specific example being taught in FIG. 2 is the cutting of a quarter arc track as illustrated by the graph 210 in lower right-center of the Figure. The student begins the exercise by using a mouse to press each button in the highlighted sections 230 of the flow chart 200. As each button is pressed one or more new lines of code are added to the CNC program 230 which is displayed above the graph as illustrated in FIG. 3. This reinforces lessons learned earlier either in prior segments of AISM or off-line (outside of AISM) about CNC programming. The student may also refer back to various elements of the curriculum using the reference section 240 of the screen. Providing the reference section 240 feature illustrates another example of how the program can provide a jump path for the student to move within the program, in this case to go from one section of material in the curriculum to another section of material within the curriculum without following a prescribed sequence.

When such a jump path is provided, it is preferable that a return path be provided so that the student may reverse the direction of movement within the program to return backwards step-by-step to the point from which the student departed from the normal linear flow of the program.

When the student has completed the viewing of all of the steps in having AISM illustrate the programming for this specific example, a screen as in FIG. 3 preferably will appear. The student presses the “next” (>) button in navigation section 390 in the lower right portion of FIG. 3. The AIS program then presents a computer-generated 3-D graphic video clip illustrating what the CNC machine will actually do when running the example computer program. The student may go back and review the instructional material as often as he/she feels is necessary to learn the programming steps.

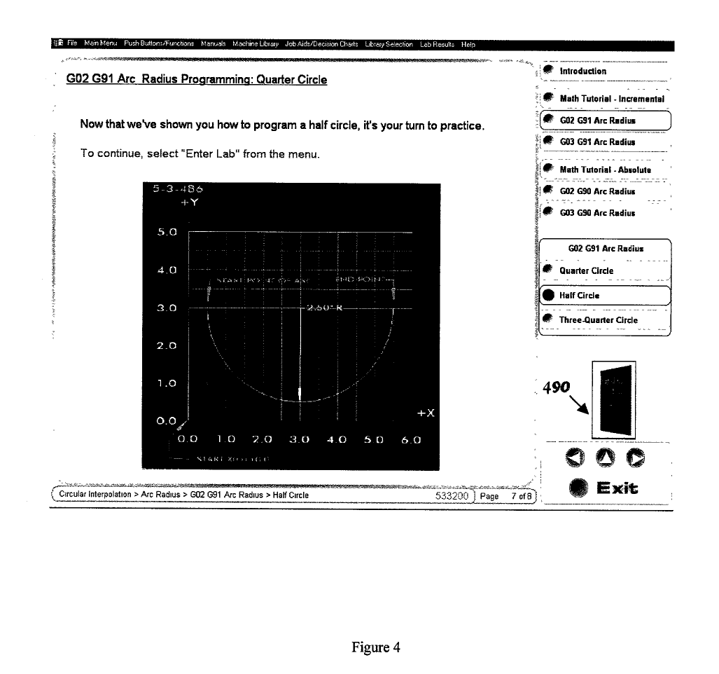

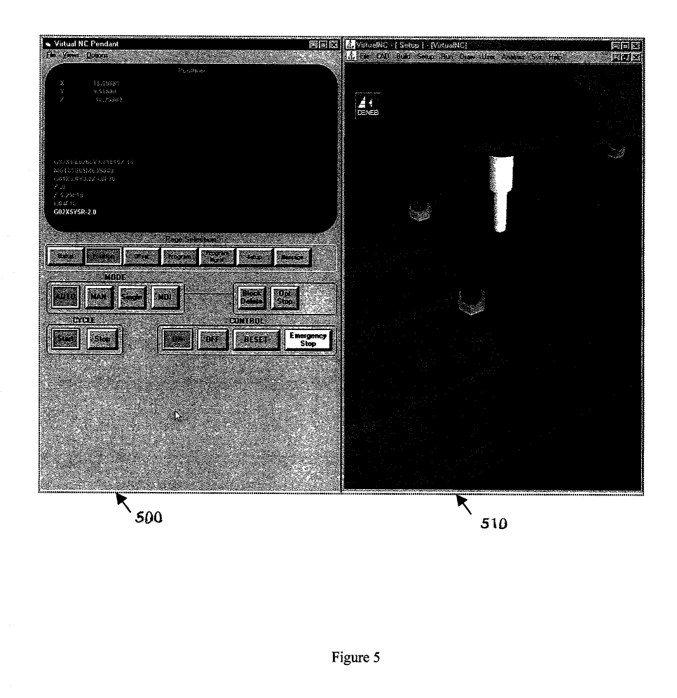

When the student feels that he/she is ready to try the programming steps himself/herself, he/she presses the button labeled “Enter Lab” 490 as illustrated in FIG. 4 to enter the laboratory. This is one example of how the program can provide a jump path to move between sections of the program, in this case from the curriculum to the laboratory. When “Enter Lab” 490 is selected a screen similar to FIG. 5 is presented. Note that the student is now presented with a simulation controller 500 on the left side of the screen and the output of a simulation engine 510 on the right side of the screen. In this embodiment the simulation controller is a generic simulation controller. In other embodiments it could be a commercial simulation controller or a hypothetical simulation controller.

The following steps are used by the student to create his/her CNC program using the simulation controller 500. The term “select” means providing an input to cause a selection, such as by using the mouse to select a menu item by clicking on it.

Select ON to power up

Select Program MGMT. The student is then presented with a submenu (not illustrated in FIG. 5) where the following steps are processed.

Select NEW

Student types in a program number that will be used to save the program

Select OK

Student must select program number he/she has written by clicking the mouse on number of program.

Select EDIT—At this time the student would write the program to match the example, as illustrated in FIG. 3.

Select SAVE

Select SAVE again

The program entered typically incorporates lines of code to set up the machine which the student learned in previous lessons presented by AISM, or from earlier off-line instruction. When the student believes that the code is correct, he/she implements the following procedure to load and run the program.

To run the selected program the student will perform the following steps

Select SELECT.

Select AUTO

Select EXIT

Select POSITION To view the program on screen.

Select START to run the program.

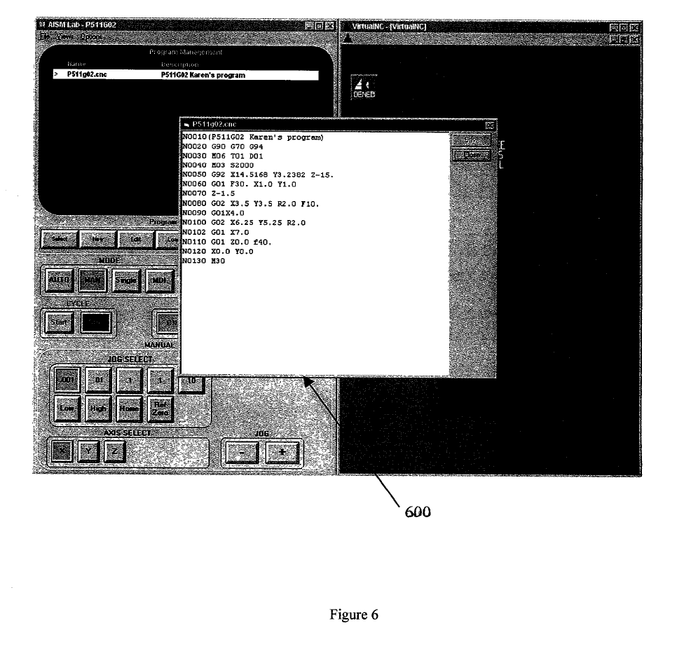

AISM now presents a computer-generated 3-D graphic video clip in the simulation engine 510 window illustrating what the CNC machine will actually do when running the student's computer program. If the student has made an error in the program it may be obvious from the video clip. For example, what would seem to be a small error in the program might cause a CNC machine to run into a clamp holding the work piece being cut, or might cause the CNC machine to bore all the way through the fixture supporting the work piece. The computer-generated 3-D graphic video clip will depict this, and may include violent color changes, visual images of flying chips, a loud noise from the computer speaker, or other dramatic audio-visual indications that the student has made a serious programming error. The student is typically given a fixed number of opportunities to correct any errors before the program is graded (scored) by AISM. FIG. 6 illustrates a program 600 written as a graded (scored) exercise.

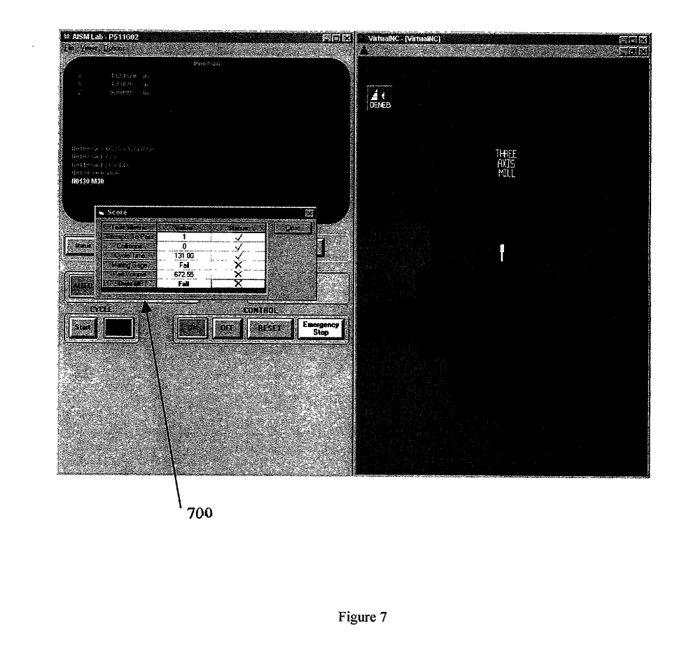

Even if a student's test program appears visually in the computer-generated 3-D graphic video to operate correctly there may be subtle mistakes or non-optimized steps that would detract from a real machining operation. To detect these mistakes, AISM conducts a detailed automatic grading or scoring process on the student's program. This grading or scoring typically includes multiple performance metrics 700 as illustrated in FIG. 7. In this example the student is graded on (1) Attempts to Pass, (2) Collisions, (3) Cycle Time, (4) Mating Gage, and (5) Part Volume. “Attempts to Pass” provides data on how many times the student needed to rework the program before submitting his/her final program. “Collisions” refers to the number of instances where the student's program causes the CNC machine to collide with it's supporting structure and mounted fixtures. “Cycle Time” refers to the amount of time the student's program consumed on the simulated CNC machine. Machine time efficiency is an important consideration in CNC programming. “Mating Gage” refers to a sophisticated computer-simulated test that AISM conducts to determine if the work piece machined by the student fits a “go/no-go” gage that would often be a final acceptance test for a real machined part. AIMS illustrates this process with a computer-generated 3-D video clip which shows the test gage moving onto the work piece, and mating successfully if the machined part passes the test. “Part Volume” refers to a calculation made by AISM to determine if the simulated machined part has the expected net material volume. This is important because the student may have programmed cuts that exceed desired volume. Such a part might pass the Mating Gage check but would still be incorrect. An alternate way to judge this performance would be to employ a slightly oversized “go/no-go” gage that should not mate with the part if it is incorrectly machined.

Another aspect of some embodiments of AISM is an ability to integrate computer simulation software with courseware. In this embodiment the curriculum is programmed using the courseware package Macromedia Authorware. The laboratory exercises and tests are programmed using Virtual Numerical Control (VNC) software by Delmia Corporation. The simulation controller is programmed using Microsoft Visual Basic, and the communication between the simulation controller and VNC is programmed using Microsoft Visual C++. In this embodiment, communication between the curriculum and the laboratory software components is accomplished through the use of a communication exchanger. The communication exchanger may consist of such mechanisms as a command line argument, or an environment setting, or a shared file, or a custom-programmed function that is added to the standard command library of the software language that is used to program the curriculum or the laboratory. In a preferred embodiment, the information passed from the curriculum to the laboratory via the communication exchanger comprises:

machine tool to use in the simulation;

the particular lab exercise to compare the finished part against;

flag indicating whether this is free time, or an exercise period (something to be graded or scored); and

the number of attempts the user is allowed at passing.

Information that is passed from the laboratory to the curriculum comprises:

the number of attempts the user took during the exercise;

collision information (e.g. Did the user run the machine or cutting tool into something? If so what and where?);

the actual machine time that the user's program took to machine the part;

flag/grade indicating whether the user's program produced the part required by the exercise (i.e. “Pass/Fail”); and

the contents of the user's CNC workpiece program.

The foregoing description of certain embodiments of this invention has been provided for the purpose of illustration only, and various modifications may be made without affecting the scope of the invention as set forth in the following claims.

We claim:

1. A computer-based method for teaching a student the proper manner of providing operational input to a system in order to achieve a desired operational outcome from the system, which comprises:
illustrating to the student an example of demonstrated operational input to a machine tool that is proper to achieve at least one specified demonstrated operational outcome on at least one demonstrated element of the machine tool;
presenting to the student a simulation of the demonstrated operational outcome on at least one demonstrated element of the machine tool;
posing to the student at least one desired operational outcome on at least one tested element of the machine tool;
collecting postulated operational input from the student which the student proposes as being appropriate to achieve at least one specified desired operational outcome on at least one tested element of the machine tool;
presenting to the student a simulation of the resulting operational outcome from the postulated operational input on at least one tested element of the machine tool

2. The method of claim 1 which further comprises conducting a simulated functional test of the results of the student's postulated operational input on at least one tested element of the system compared with the specified desired operational outcome corresponding to each such tested element of the system.

3. The method of claim 1 which further comprises conducting a simulated functional test on at least one element of the system based upon the demonstrated operational outcome after presenting a simulation of the demonstrated operational outcome.

4. The method of claim 1 which further comprises scoring the results of the student's postulated operational input using more than one desired operational outcome and comparing the score with a minimum acceptance standard.

5. The method of claim 4 which further comprises providing more than one but less than ten attempts for the student to enter postulated operational input in order to achieve a score that meets the minimum acceptance standard.

6. The method of claim 1 in which a simulation controller is used to illustrate the entry of demonstrated operational input and accept the entry of postulated operational input.

7. The method of claim 1 in which a generic simulation controller is used to illustrate the entry of demonstrated operational input and accept the entry of postulated operational input.

8. The method of claim 1 in which a hypothetical simulation controller is used to illustrate the entry of demonstrated operational input and accept the entry of postulated operational input.

9. The method of claim 1 which further comprises:
using a generic simulation controller to illustrate to the student an example of demonstrated operational input to a system that is proper to achieve at least one specified demonstrated operational outcome on at least one demonstrated element of the system;
presenting to the student a simulation of the demonstrated operational outcome on at least one demonstrated element of the system based upon the demonstrated operational input from the generic simulation controller;
using a commercial simulation controller to illustrate to the student an example of demonstrated operational input to a system that is proper to achieve at least one specified demonstrated operational outcome on at least one demonstrated element of the system; and
presenting to the student a simulation of the demonstrated operational outcome on at least one demonstrated element of the system based upon demonstrated operational input from the commercial simulation controller.

10. The method of claim 1 which further comprises:
using a generic simulation controller to illustrate to the student an example of demonstrated operational input to a system that is proper to achieve at least one specified demonstrated operational outcome on at least one demonstrated element of the system;
presenting to the student a simulation of the demonstrated operational outcome on at least one demonstrated element of the system based upon the demonstrated operational input from the generic simulation controller;
posing to the student at least one desired operational outcome on at least one tested element of the system;
using said generic simulation controller to collect postulated operational input from the student which the student proposes as being appropriate to achieve at least one specified desired operational outcome on at least one tested element of the system;
presenting to the student a simulation of the resulting operational outcome from the postulated operational input on at least one tested element of the system based upon the postulated operational input from the generic simulation controller;
using a commercial simulation controller to illustrate to the student an example of demonstrated operational input to a system that is proper to achieve at least one specified demonstrated operational outcome on at least one demonstrated element of the system;
presenting to the student a simulation of the demonstrated operational outcome on at least one demonstrated element of the system based upon demonstrated operational input from the commercial simulation controller;
again posing to the student at least one desired operational outcome on at least one tested element of the system;
using said commercial simulation controller to collect postulated operational input from the student which the student proposes as being appropriate to achieve at least one specified desired operational outcome on at least one tested element of the system;
presenting to the student a simulation of the resulting operational outcome from the postulated operational input on at least one tested element of the system based upon the postulated operational input from the commercial simulation controller.

11. The method of claim 1 which further comprises providing to the student background reference material which is relevant to the application of operational input to a system.

12. Computer software recorded on a computer-readable medium, which comprises:
a curriculum comprising background material and tutorial material whereby the proper manner of providing operational input to a system in order to achieve a desired operational outcome from the system is presented to a student; and
a laboratory comprising a simulation controller and a simulation engine whereby the student's understanding of the proper manner of providing operational input to a system in order to achieve a desired operational outcome from the system is tested; and
a communication exchanger whereby data are transferred between said curriculum and said laboratory.

13. The software of claim 12 wherein the laboratory further comprises a jump path from the laboratory to the curriculum, and the curriculum further comprises a return path from the curriculum to the laboratory.

14. The software of claim 12 wherein the communication exchanger is selected from the group consisting of a command line argument, an environment setting, a shared file and a custom function.

15. The software of claim 12 wherein the tutorial material comprises at least one flow-chart.

16. The software of claim 15 wherein the flow-chart comprises at least two alternative branches from which the student may select instructional material.

17. A computer-based method for teaching a student how to program a computer numerical control machine, which comprises:
a curriculum teaching process, comprising:
showing the student how to determine the locus of a point on a coordinate axes of at least two dimensions, and
demonstrating to the student how to program the computer numerical control machine to make a cut from one demonstration locus to a second demonstration locus on the coordinate axis associated with a demonstration workpiece using a flow chart to depict the programming steps and a generic simulation controller to enter the demonstrated computer numerical control program; and
using a simulation engine to depict the results of using the demonstrated computer numerical control program to cut the demonstration work piece, and
using the simulation engine to display a functional test of the demonstration workpiece after using the demonstrated computer numerical control program, and
providing the student the option of returning to previous steps of the curriculum teaching process, and
providing the student the option of advancing to a testing laboratory process; and
a testing laboratory process comprising:
posing to the student a question of how to program the computer numerical control machine to make cut from one test locus to a second test locus on the coordinate axis associated with a test workpiece, and
collecting the student's postulated computer numerical control program using the generic simulation controller, and
using the simulation engine to depict the results of using the student's postulated computer numerical control program to cut the test workpiece, and
using the simulation engine to display a functional test of the test workpiece after cutting using the student's postulated computer numerical control program, and
providing the student the option of returning to previous steps of the testing laboratory process, and
providing the student the option of advancing to a graded laboratory process; and
a graded laboratory process comprising:
posing to the student a question of how to program the computer numerical control machine to make a cut from a first graded locus to a second graded locus on the coordinate axis associated with a graded workpiece, and
collecting the student's tested computer numerical control program using the generic simulation controller, and
using the simulation engine to depict the results of using the student's tested computer numerical control program to cut the test workpiece, and
using the simulation engine to display a functional test of the test workpiece after cutting using the student's graded computer numerical control program, and
scoring the student's graded computer numerical control program using more than one desired operational outcome; and
providing the student at least one opportunity to return to the beginning of the graded laboratory process if the student fails to achieve a passing score on the graded computer numerical control program.

18. A computer based method for teaching a student the proper manner of providing operational input to a computer controlled machining system in order to produce a desired machined part, comprising:
prompting a student to provide a computer program for machining a particular workpiece,
collecting a computer program from the student,
calculating and visually and aurally representing the operation of the machining system that would be produced by the computer program collected from the student, said representing including catastrophic visual and aural effects when errors are detected in the collected computer program that would cause catastrophic failures in the manufacture of the particular part.

19. The method of claim 18 further comprising displaying a machine tool colliding with a mounting fixture of the machining system when the postulated computer numerical control program collected from the student directs the computer controlled machining system to machine in a position corresponding to the mounting fixture.

20. The method of claim 18 further comprising aurally representing a machine tool colliding with a mounting fixture of the machining system when the postulated computer numerical control program collected form the student directs the machining system to machine in a position corresponding to the mounting fixture.

21. The method of claim 18 further comprising interactively displaying background material to a student to teach the operation of a computer controlled machining system, the background material including examples of computer programs for machining a desired part.

22. A computer based method for teaching a student the proper manner of providing operational input to a system in order to achieve a desired operational outcome form the system, comprising:
displaying to the student graphics illustrating at least one approach to providing operational input to a system, said graphics being selected from either a linear graphic for teaching only one approach or a branched graphic for teaching alternate approaches to providing operational input to a system,
said branched graphic providing a presentation of at least two alternative approaches to allow comparison of the two approaches in context,
when displaying a branched graphic, receiving input from the student to select one of the alternate approaches,
collecting postulated operational input from the student corresponding to one of the approaches,
presenting to the student a simulation of the resulting operational outcome from the postulated operational input.
